(19) United States
(12) Patent Application Publication
(10) Pub. No.: US 2024/0400938 A1
(43) Pub. Date: Dec. 5, 2024

(54) Candles and Related Components and Methods

(71) Applicant: FireFly Innovations LLC, Payson, UT (US)

(72) Inventor: Kristen Suzanne Southwick, Payson, UT (US)

(73) Assignee: FireFly Innovations LLC, Payson, UT (US)

(21) Appl. No.: 18/676,898

(22) Filed: May 29, 2024

Related U.S. Application Data
(60) Provisional application No. 63/504,887, filed on May 30, 2023.

(51) Int. Cl. C11C 5/00; C11C 5/02

(52) U.S. Cl. CPC C11C 5/008; C11C 5/002; C11C 5/006; C11C 5/023

(57) ABSTRACT

A candle includes a flammable medium that is at least semi-solid. A wick assembly is at least partially integrated within the flammable medium. The wick assembly includes a wick having a top end and a bottom end and at least one stop coupled with the wick between the top end and the bottom end. The stop is configured to substantially prevent the candle from burning beyond the stop. The stop is configured to be manually removable, after the wick has burned from the top end to the stop, to substantially separate a burned portion of the wick from a remainder of the wick. After the burned portion and stop have been thus manually removed, a substantially non-burned top portion of the remainder is exposed and is capable of being ignited to re-light the candle.

### CROSS REFERENCE TO RELATED APPLICATIONS

This document claims the benefit of the filing date of U.S. Provisional Patent Application No. 63/504,887, entitled “Candles and Related Components and Methods,” naming as first inventor Kristen Suzanne Southwick, which was filed on May 30, 2023, the disclosure of which is hereby incorporated entirely herein by reference.

### BACKGROUND

### 1. Technical Field

Aspects of this document relate generally to candles that are burned for light and/or for scent.

### 2. Background Art

A variety of candles of differing sizes, shapes, and colors exist in the art. Candles often include a wick embedded within a solid wax element. Some candles are further disposed within containers, such as a glass jar. When lit, candles may be used as a source of light. Some candles also include one or more scented elements and are configured to provide a scent when lit.

### SUMMARY

In some aspects, the techniques described herein relate to a candle, including: a flammable medium that is at least semi-solid; and a wick assembly at least partially integrated within the flammable medium, the wick assembly including: a wick including a top end and a bottom end; and a stop coupled with the wick between the top end and the bottom end; wherein the stop substantially prevents the candle from burning beyond the stop until the stop is removed; and wherein the stop is configured to be manually removed, after the wick has burned from the top end to the stop, to substantially separate a burned portion of the wick from a substantially non-burned top portion of a remainder of the wick, the substantially non-burned top portion capable of being ignited to re-light the candle.

In some aspects, the techniques described herein relate to a candle, wherein the stop includes a base, a hollow riser coupled with the base, and an opening at an end of the hollow riser, and wherein the wick passes through the opening and through the hollow riser.

In some aspects, the techniques described herein relate to a candle, wherein the stop is positioned so that the hollow riser extends away from the base and toward the top end of the wick.

In some aspects, the techniques described herein relate to a candle, wherein the stop is positioned so that the hollow riser extends away from the base and toward the bottom end of the wick.

In some aspects, the techniques described herein relate to a candle, wherein the hollow riser is crimped to secure the stop to the wick.

In some aspects, the techniques described herein relate to a candle, wherein the stop is formed of a metal or a metal alloy.

In some aspects, the techniques described herein relate to a candle, further including one or more additional stops coupled with the wick between the top end and the bottom end.

In some aspects, the techniques described herein relate to a candle, wherein the stop and the one or more additional stops are positioned at substantially equal intervals along the wick.

In some aspects, the techniques described herein relate to a candle, further including a base member proximate or at a bottom of the candle and proximate or at the bottom end of the wick, the base member including: a base; a hollow riser coupled with the base; and an opening at an end of the hollow riser; wherein the wick passes through the opening and through the hollow riser.

In some aspects, the techniques described herein relate to a candle, wherein the base member is positioned so that the hollow riser extends away from the base and toward the top end of the wick.

In some aspects, the techniques described herein relate to a candle apparatus, including: a wick including a top end and a bottom end; and a stop including a metallic hollow riser having an opening, wherein the stop is configured to secure to the wick between the top end and the bottom end, by passing the wick through the opening and through the metallic hollow riser, to form a wick assembly; wherein the wick assembly is configured to be at least partially integrated within a flammable medium to form a candle; wherein the stop, when secured to the wick, is configured to extinguish a flame consuming the wick as the flame approaches the stop; and wherein the stop is configured to be manually removable, after the wick has burned from the top end to the stop, to substantially separate a burned portion of the wick from a substantially non-burned top portion of a remainder of the wick, the substantially non-burned top portion capable of being ignited to re-light the wick.

In some aspects, the techniques described herein relate to a candle apparatus, wherein the stop is secured to the wick.

In some aspects, the techniques described herein relate to a candle apparatus, wherein the stop is secured to the wick by the wick being situated at least partially within the metallic hollow riser and the metallic hollow riser being crimped.

In some aspects, the techniques described herein relate to a candle apparatus, further including the flammable medium.

In some aspects, the techniques described herein relate to a candle apparatus, wherein the stop further includes a base coupled with the metallic hollow riser, the base forming a pull tab.

In some aspects, the techniques described herein relate to a candle apparatus, wherein the stop is secured to the wick and is positioned so that, when the wick is substantially aligned in a straight line, the metallic hollow riser extends away from the base and toward the top end of the wick.

In some aspects, the techniques described herein relate to a candle apparatus, wherein the stop is secured to the wick and is positioned so that, when the wick is substantially aligned in a straight line, the metallic hollow riser extends away from the base and toward the bottom end of the wick.

In some aspects, the techniques described herein relate to a candle apparatus, further including a base member configured to secure to the bottom end of the wick, the base member including: a base; a hollow riser coupled with the base of the base member; and an opening at an end of the hollow riser of the base member; wherein the wick is configured to secure to the base member at least in part by the wick passing through the opening of the base member and through the hollow riser of the base member.

In some aspects, the techniques described herein relate to a method of forming a candle, including: providing a wick having a top end and a bottom end; providing a stop including: a base; and a hollow riser having an opening; passing the wick through the hollow riser and through the opening so that the stop is positioned between the top end and the bottom end; securing the stop to the wick to form a wick assembly; situating the wick assembly at least partially within a flammable medium while the flammable medium is in an at least semi-liquid state; and solidifying the flammable medium to an at least semi-solid state with a first portion of the wick assembly within the flammable medium and a second portion of the wick assembly outside the flammable medium, to form a candle; wherein the stop is configured to extinguish a flame consuming the candle as the flame approaches the stop; and wherein the stop is configured to be manually removable, after the wick has burned from the top end to the stop, to substantially separate a burned portion of the wick from a substantially non-burned top portion of a remainder of the wick, the substantially non-burned top portion capable of being ignited to re-light the candle.

In some aspects, the techniques described herein relate to a method of forming a candle, wherein forming the wick assembly further includes: providing a base member including: a base; a hollow riser coupled with the base of the base member; and an opening at an end of the hollow riser of the base member; passing the bottom end of the wick through the opening of the base member and through the hollow riser of the base member; and securing the bottom end of the wick to the base member; wherein positioning the wick assembly at least partially within the flammable medium includes positioning the base member at least partially within the flammable medium.

General details of the above-described implementations, and other implementations, are given below in the DESCRIPTION, the DRAWINGS, the CLAIMS and the ABSTRACT.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1 is a top, front, perspective view of an implementation of a base member of the wick assembly of FIG. 4;

FIG. 2 is a top, front, perspective view of an implementation of a removable stop of the wick assembly of FIG. 4;

FIG. 3 representatively illustrates a step in forming the wick assembly of FIG. 4;

FIG. 4 is a top, front, perspective view of an implementation of a wick assembly;

FIG. 5 is a bottom, rear, perspective view of the wick assembly of FIG. 4;

FIG. 6 is a top, front, perspective view of a portion of the wick assembly of FIG. 4 after the wick has been partially burned and some of the removable stops have been removed;

FIG. 7 is a top, front, perspective view of a lit candle including the wick assembly of FIG. 4;

FIG. 8 is a top, rear, perspective view of the candle of FIG. 7 after the flame has extinguished due to a removable stop; and

FIG. 9 is a top view of the candle of FIG. 8 and representatively shows a user removing the removable stop and a burned portion of the wick.

### DESCRIPTION

Implementations/embodiments disclosed herein (including those not expressly discussed in detail) are not limited to the particular components or procedures described herein. Additional or alternative components, assembly procedures, and/or methods of use consistent with the intended candles and related components and methods may be utilized in any implementation. This may include any materials, components, sub-components, methods, sub-methods, steps, and so forth.

Referring first to FIGS. 4-6, a first implementation of a wick assembly 105 is shown. The wick assembly includes a wick 106. The wick could be made of a variety of materials, some of which are known in the art and some of which may be discovered hereafter. By non-limiting example, the wick could be formed from cotton, wool, wood, moss, jute, thistle fluff, grass, bark (such as birch bark), paper, hop stalk(s), rush, pine needles, plantago, orange pith, straw, nettle, bramble, linen, silk, sisal, mullein, lime bast, any other material reasonably capable of functioning as a wick, and any combination thereof. Combinations could include one material wrapped around the other, such as a thin wood with a cotton string wrapped around it from top to bottom. The wick may include multiple strings, threads, or cords that are twisted, braided, or otherwise coupled together in any configuration. The wick could be configured as a cord, twine, yarn, and/or as any other configuration.

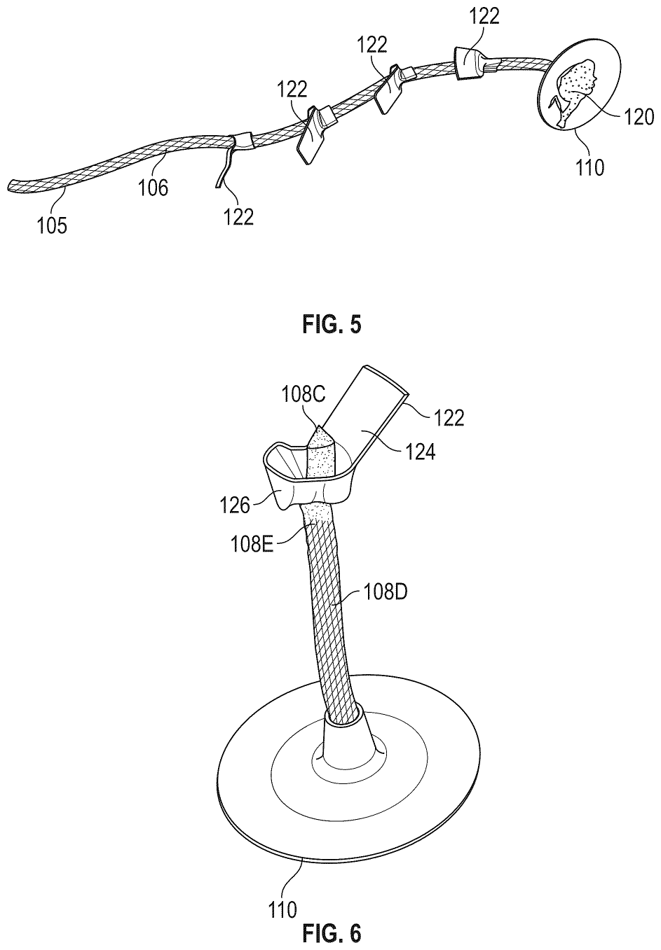

In implementations the wick 106 includes a top end 108A and an opposite bottom end. The bottom end is not actually visible in the drawings, but in the example of FIGS. 4-5 the bottom end is identical to the top end and is located at or proximate the bottom of the base member 110. The bottom end is not visible in FIG. 5 because it is covered with the adhesive 120 which secures the bottom end to the base member. In implementations the adhesive could be transparent so that the bottom end is actually visible. It is pointed out that the terminology of the bottom end being secured to the base member does not imply that there is nothing therebetween—for example when an adhesive is used the adhesive may be situated between the bottom end and the base member, the adhesive securing the base member and the bottom end to one another. In implementations the wick is secured to the base member at least in part by the wick passing through the opening and hollow riser of the base member, e.g., through a manually-removable friction fit. As a candle (into which the wick is integrated) burns, a burned portion 108C of the wick forms, leaving a remainder 108D that is substantially not burned. The remainder includes top portion 108E.

The wick could be formed into a variety of shapes, such as cylindrical (as in FIG. 4), braided flat (so that as it burns it also curls back into the flame, thus making it self-consuming, and/or to create a brighter/better flame), and so forth. The wick could be formed using any of a range of diameters so as to affect the flame size as desired. The wick could be any length from the top end to the bottom end according to the desired size of the candle into which it is integrated.

Although not shown in the drawings, the wick could include a stiffener (such as copper wire or the like) to make the wick more rigid and/or to conduct heat downward, melting the wax more readily. The latter may be more particularly useful for candles made of harder wax.

As is common in the industry, the wick may be treated with any of a variety of flame-resistant solutions in a process known as mordanting. Mordanting may help prevent the wick from being destroyed by the flame, which can cease the flow of melted wax to the flame (in some implementations mordanting may only slow down the destruction of the wick by the flame). The wick may also be treated with substances to adjust the color and/or brightness of the flame, provide better rigidity to keep the wick out of the melted wax (or other flammable medium), and improve the flow of that wax (or other flammable medium) up the wick. Common treatments are borax and salt which are dissolved in water in which the wicks are soaked.

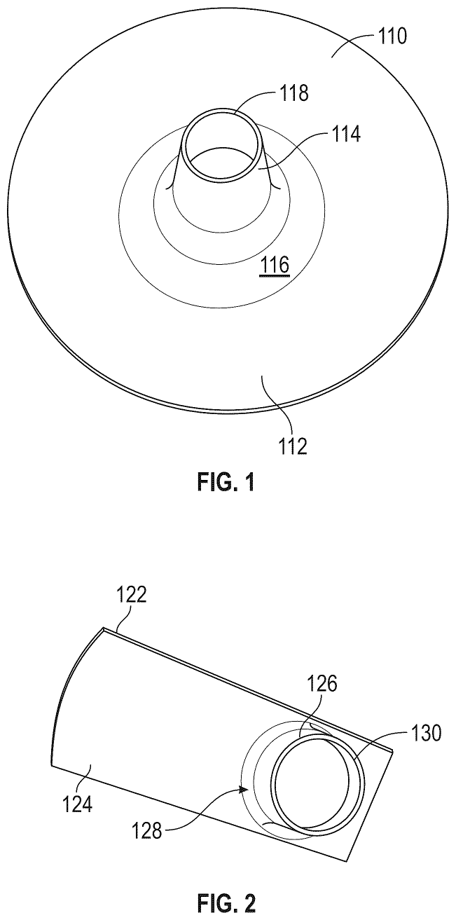

Referring still to FIGS. 4-6, and also to FIG. 1, the wick assembly 105 includes a base member 110 coupled with, or at, or proximate the bottom end of the wick. The base member includes a base 112 and a hollow riser 114. A curved surface 116 is present where the base transitions to the riser. In some implementations the riser itself includes curvature such that the curved surface 116 extends all the way from the base to the top of the riser and, therefore, the curved surface and riser are coextensive. In FIG. 1 the curvature does not extend all the way to the top of the riser but a portion of the riser is simply conical (having a shape of a hollow frustum of a cone) from the curved surface to the top of the riser. The riser includes an opening 118 sized to allow the wick to pass therethrough. In implementation the curved surface may facilitate the wick being more easily passed through the opening from the bottom of the base (i.e., the wick exiting the opening after having been passed through the riser). Nevertheless, in implementations the wick may be passed opening-first through the base member (i.e., being passed first through opening 118). After the wick has been passed through the base member the bottom end may be secured to the underside of the base member, such as with an adhesive 120. The bottom end of the wick (or the wick proximate its bottom end) could be secured to the base member in some other manner, such as being cinched within a slit in the base or through some other mechanism.

In implementations the base member is formed of a metal, such as aluminum, copper, steel, tin, brass, or any other metal or alloy, or any other material. In implementations it is formed of a material which may be easily plastically deformed to crimp the riser to the wick. In implementations, as in FIG. 4, the crimping of the base member to the wick may be excluded (such as in implementations wherein the wick is glued or otherwise secured to the base member, as in FIGS. 4-5), though in some cases the riser could be crimped to the wick and, additionally, the wick could be further secured to the base member using an adhesive or in some other manner.

The base member may be useful during formation of a candle by helping the bottom end of the wick stay at a bottom of a container or mold or the like, by gravity, while a liquified flammable medium (such as a molten wax, a gel, etc.) is poured therein and then solidified (or semi-solidified, such as in the case of a gel) to form the candle. The base may also provide some stability so that the wick does not pull out of the candle, even if the candle is carried (during manufacturing or otherwise) by gripping the top end (or proximate the top end) of the wick (e.g., a portion of the wick extending beyond a top of the solidified or semi-solidified flammable medium). Additionally, when the candle is short enough (either as initially formed, or after some use) such that the column of melted wax reaches down to the base member (in other words, when the wax is liquified all the way down to the base member), the base member's weight, by gravity, may prevent the wick from floating to the top of the molten wax and burning before the wax does.

As used herein, the term/phrase “semi-solid” is defined as a state of matter between liquid and solid. Semi-solids are sometimes also referred to as quasi-solids. Examples of semi-solids are mayonnaise, warm butter, milk curds, gels, and creams that do not hold their shape like a solid but also do not flow like a liquid. Some semi-solids include covalent bonds and, under increasing temperature, get softer (more liquid-like) until they melt. Other semi-solids include ionic bonds and, under increasing temperature, do not get softer (more liquid-like) until they reach their melting temperature. The phrase “at least semi-solid” and variants thereof, as used herein, indicates either a semi-solid state of matter or a solid state of matter.

The flammable medium may, in implementations, not be flammable in solid (or otherwise non-liquid) form, but may be flammable once liquified and/or vaporized proximate the flame. The flammable medium may be any type of wax (beeswax, paraffin, animal wax, plant wax, etc.), tallow, fat, oil, spermaceti, stearin, any combination thereof, and so forth. The flammable medium could be solid once the candle is fully formed, or it could be semi-solid (for example a gel candle).

Referring to FIGS. 2-6, one or more removable stops 122 may be coupled with the wick, at desired intervals. The removable stops are in some ways similar to the base member, each including a base 124, a riser 126, a curved surface 128, and an opening 130. The base 124, however, has a somewhat different shape than base 112, and forms (and functions as) a pull tab. In implementations the removable stops may alternatively have a shape the same as, or substantially similar to, the base member 110. In implementations removable stops 122 are formed by cutting portions of the base 112 of a base member 110 to the shape shown in FIG. 2.

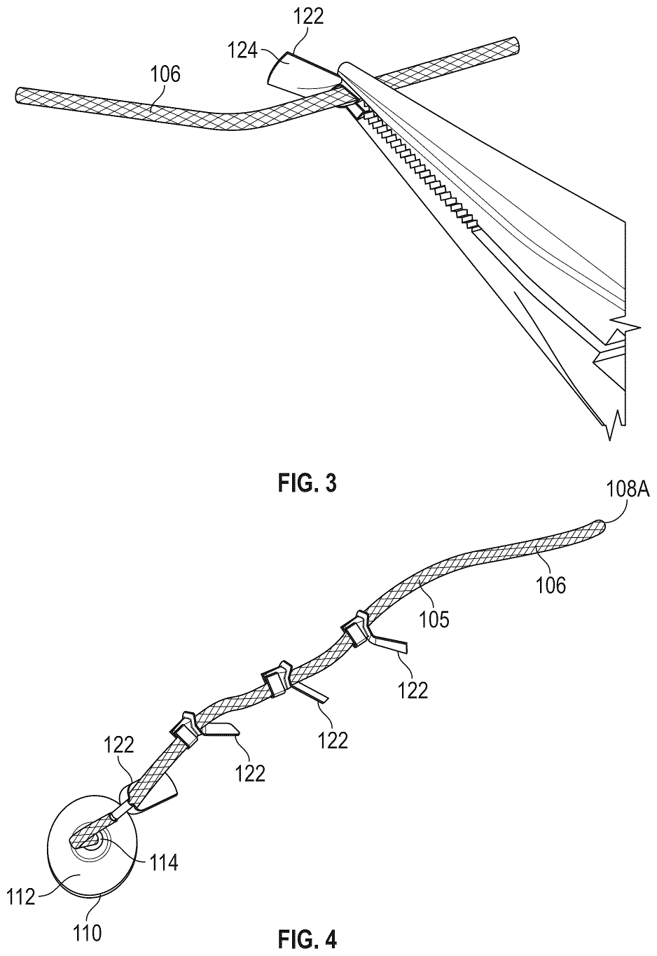

The components/elements of stops 122 may have the same, or similar, or identical functions as similarly-named elements of the base member, and may be formed of the same or similar materials. The riser 126 may be crimped, as illustrated in FIG. 3 where needle-nose pliers are being used to crimp the riser, to secure the stop at a desired position along the wick (in the same way, riser 114 may be crimped to secure the base member at a desired position along the wick). FIGS. 4-6 show a number of stops that have been secured to the wick in this way, along with a base member.

FIG. 6 representatively illustrates a useful function of the wick assembly. This functionality occurs while the wick assembly is integrated within a candle but, for purposes of illustration, in FIG. 6 the flammable medium of the candle is not shown so that the mechanisms facilitated by the wick assembly may be more easily envisioned. When the wick assembly is integrated within a candle and the wick is ignited or lit, such as with a lighter or match, the flame of the wick acts the same as with all candles. The flammable medium proximate the flame is melted to a liquid form, then drawn (or wicked) up the wick using capillary action so that it is proximate the flame, where it is vaporized. The vaporized flammable medium combines with oxygen and burns in the flame, thus fueling the flame.

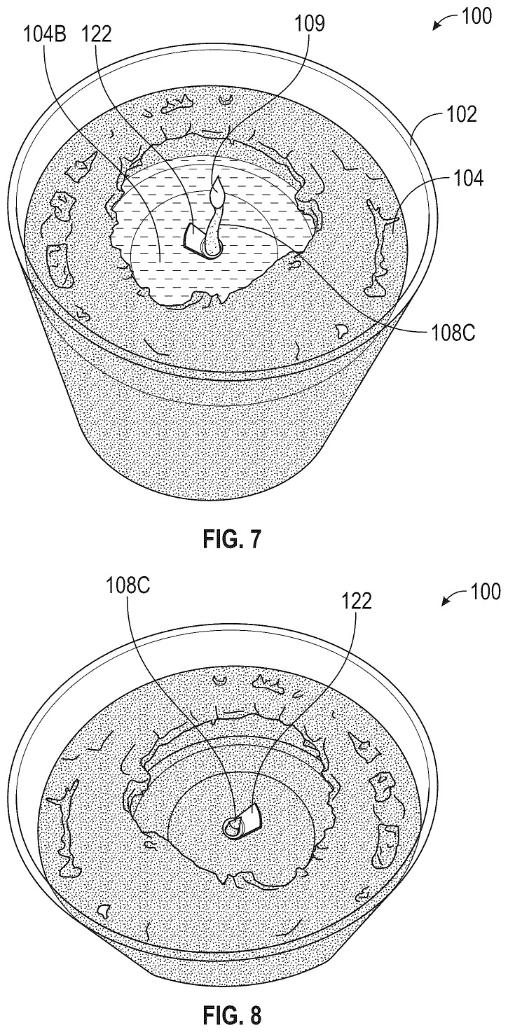

However, as the candle continues to burn and the wick is consumed and shortened, eventually the burned portion 108C of the wick reaches proximate a stop 122, as representatively illustrated in FIG. 7 (which also shows a molten portion 104B of the flammable medium 104 such as, by non-limiting example, molten wax below or proximate the flame 109). Because the riser of the stop is crimped around the wick, the stop decreases, substantially decreases, or prevents wicking action of the wick thereat-reducing, substantially reducing, or preventing flow of the molten flammable medium upwards. The stop may be formed of the same material as the base member (or of any material otherwise disclosed herein as being an optional material for the base member). The material of the stop, although it may be made of a material with high thermal conductivity (such as a metal), nevertheless provides a barrier between the flame and the flammable material directly below it, which reduces or hinders or prevents the liquification of the flammable medium thereat. Any or all of these factors, alone or in combination with other factors, create a situation such that the flame extinguishes as it approaches the stop, at or proximate the stop, as representatively illustrated in FIG. 8 (and it is for this reason that the component is called a stop). In some cases a portion of the wick below the stop may burn somewhat but, in general, because the stop prevents burning of the wick proximate the stop, in implementations the stop substantially prevents the candle and/or wick from burning beyond the stop. In some cases this means that the wick stops burning within 1.0, 0.9, 0.8, 0.7, 0.6, 0.5, 0.4, 0.3, 0.2, or 0.1 inches or cm or mm from the bottom of the base of the stop (in either direction).

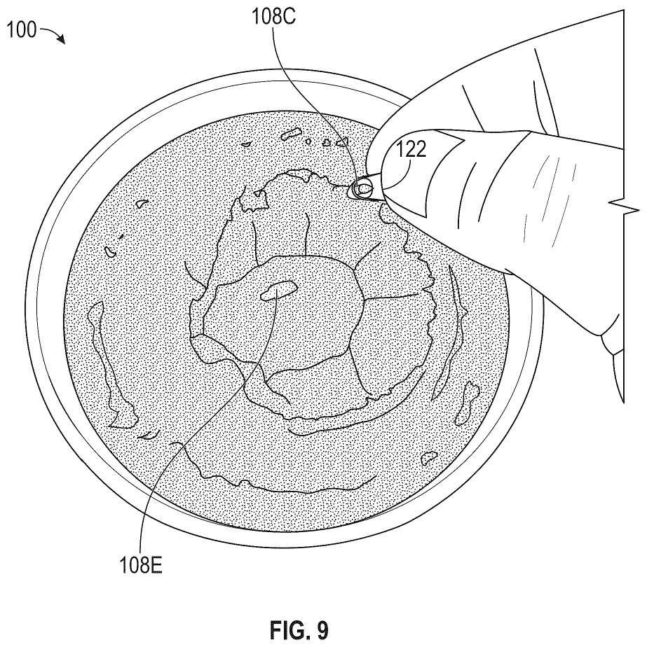

Once the flame self-extinguishes in this manner, the wick assembly within the candle has the configuration similar to that shown in FIG. 6, wherein an extinguished burned portion 108C exists above the stop (and may to some extent extend below the stop, as depicted in FIG. 6), and a remainder 108D of the wick, having a top portion 108E which is not burned, exists below the stop. The user may manually remove the stop, such as with fingers or pliers or the like, as in FIG. 9. This breaks the wick proximate the intersection of the burned portion and the remainder, exposing the top portion 108E (or exposing the wick above or proximate the top portion) which may have some burned material still thereon. Once the stop is removed the wick may be re-lit in order to begin the burning process again, and the candle will again burn until it reaches the next stop (or, after the last stop has been removed, until the candle fully expires at its base).

Because the removed portion of the wick (which is removed when the stop is removed) may in some cases not remove the entire burned portion, but may snap off the wick somewhere between the top and bottom of the burned portion, it is stated herein that the stop, when removed, substantially separates the burned portion of the wick from the remainder of the wick, thereby exposing a substantially non-burned top portion of the remainder capable of being reignited to re-light the candle. In implementations the language “substantially separates” means that the stop removal removes ninety-five, ninety, eighty-five, eighty, seventy-five, seventy, sixty-five, sixty, fifty-five, fifty, forty-five, forty, thirty-five, thirty, twenty-five, or twenty percent of the burned portion of the wick. The phrase “substantially non-burned top portion,” as it relates to the wick, in implementations simply means a portion that, even if it is somewhat burned, can be re-lit to reignite the candle and wick the liquid flammable medium upward to fuel the new flame (as opposed to a fully burned portion that will no longer wick liquid flammable material upward to fuel a flame and/or that will not reignite).

Any number of stops may be used in a candle, as desired by the user. The stops provide a convenient way to allow a candle to burn for a period of time but then to self-extinguish. This helps to conserve the candle for future uses and may also provide some safety against the fire hazard of an unattended candle. In some cases the stops may be placed at intervals such that the candle will burn for known times (plus or minus some range) from stop to stop (and from the top end to the first stop, and from the last stop to the base member).

FIGS. 7-9 show that candles 100 may be formed which include the wick assembly 105 integrally formed within a flammable medium 104 (which flammable medium, as described above, may be made of a variety of materials). This may be done by holding or securing the wick assembly in an upright fashion within a mold, or within a container 102, while the liquified/molten or semi-liquified/semi-molten flammable medium (or, in other words, a flammable medium in an at least semi-liquid state or an least semi-molten state) is poured therein, and then allowing the flammable medium to solidify to a solid state or a semi-solid state. Alternatively, the flammable material may be liquified and then the wick assembly lowered therein until the base member is at the bottom of the flammable material and leaving a top portion of the wick extending above a top of the liquified flammable material, and the flammable material may then be allowed to solidify to a solid or semi-solid state. The mold may then be removed (or in the case of container 102, the container 102 which effectively serves as a mold may remain). When a container 102 is used the flammable medium is at least partially contained within the container 102 in the finished state, but the container is optional and, in implementations, the candle 100 may exclude the container 102.

While the example base members and removable stops disclosed herein are formed of metals, in other implementations they could be formed of other non-flammable materials configured to be crimped, such as composite materials. In some implementations the removable stops are not crimped onto the wick but are otherwise secured thereto, such as using a non-flammable adhesive, or through a friction fit (the opening of the stop being small enough that movement of the stop relative to the wick is prevented until enough manual force is applied), and so forth.

In the implementations shown in the drawings the wick is a continuous piece from the top end to the bottom end. In other implementations the wick could include multiple separate pieces that are joined or coupled together using the crimped removable stops so that there is actually a gap between wick portions, which may serve to further stop the flame proximate the stop (by further preventing or slowing wicking thereat).

In implementations the base member may be used to secure the wick to the bottom of a jar or other container. This could include using the adhesive 120 (or an additional adhesive, such as hot glue from a molten glue gun or glue stick, or even a small portion of the flammable medium) to secure the base member to the bottom of the jar or container prior to the bulk of the molten flammable medium (wax, gel, etc.) being poured into the jar or container. In other implementations the base member is not secured to the bottom of the jar or container but is simply positioned at or proximate the bottom of the jar or container before the molten flammable medium is poured into the jar (or is otherwise lowered into the molten flammable medium). In either case, as the molten flammable medium solidifies or semi-solidifies the base member is secured in place (or is further secured in place) and the wick is also secured in place. In some cases the top end of the wick (or the wick proximate the top end) may be held up while the flammable medium is initially setting/solidifying (or at least partially solidifying), though in other implementations the molten flammable medium is viscous enough that the wick generally stays in an upright position during setting/solidification (or semi-solidification, such as in the case of a gel).

When the candle has finished being formed (such as by the flammable material solidifying or reaching a semi-solid state) the base member may be exposed through a bottom of the at least semi-solid flammable material, in which case it may be said that the base member is at the bottom of the candle and/or at the bottom of the flammable material. In some cases, however, the base member may be partially or fully covered by the flammable material thereat but, nevertheless, still proximate the bottom of the candle once the flammable material is in its at least semi-solid state. As used herein, the base member being “proximate” the bottom of the candle may refer to the base member being within ten, or nine, or eight, or seven, or six, or five, or four, or three, or two, or one mm from the bottom of the candle.

In some cases the base member may be secured to the bottom end of the wick in such a way that the bottom end of the wick physically contacts the base member. In such cases it may be said that the base member is at the bottom end of the wick. In other cases the bottom end of the wick may be adhered to the base member with an adhesive and/or may otherwise be situated such that the bottom end of the wick is not directly contacting the base member but is nevertheless proximate thereto. As used herein, the base member and bottom end of the wick being “proximate” one another may refer to the base member being within ten, or nine, or eight, or seven, or six, or five, or four, or three, or two, or one mm from the bottom end of the wick.

The candle, including the flammable medium and/or any container, could be formed into any shape, and need not strictly be formed into cylindrical shapes such as those shown in the drawings. Various candle shapes are known in the art and the practitioner of ordinary skill in the art will know how to incorporate the wick assemblies disclosed herein within such candles of varying shapes.

In summary, as described herein, in implementations once the flame reaches a stop (whether formed of aluminum or another metal or other material), and finishes burning off some of the exposed wick above the stop, the flame self-extinguishes. The stop is then easily pulled off, breaking a portion of the wick in the process and exposing a portion of the wick capable of being reignited.

Although the stops shown herein are cut from base members (or, in other words, formed by cutting portions of the bases of base members), in implementations they could originally be manufactured into the shape shown in FIG. 2 or a similar or somewhat modified shape. The shapes shown herein for base members and removable stops are only examples, and in other cases other shapes could be used, though in some cases it may be useful to have the risers (for crimping onto the wick), the pull tabs for easy grasping and removal of a stop, and the bases for easy positioning/resting of a base member (such as during candle fabrication).

In FIGS. 3-9 each stop is positioned so that, when the wick assembly is upright (as it would be in a fully-formed candle) (in other words when the wick is fully or substantially aligned in a straight line, such as pulled from end to end with the top end up and the bottom end down), the stop's opening 130 faces downward, toward the bottom end of the wick, and with the base above the riser (in other words, the hollow riser extends away from the base of the stop and toward the bottom end of the wick). In other implementations (again when the wick is fully or substantially aligned in a straight line with the top end up and bottom end down, as detailed above) each stop could be positioned with its opening 130 facing upward, toward the top end 108A of the wick (in other words, the hollow riser extending away from the base of the stop and toward the top end of the wick). In testing it has been found that this latter configuration, with the hollow risers extending away from the bases and toward the top of the wick, results in better flame-stopping performance when the flame reaches the stops. Other configurations and modifications are possible, such as alternating upward and downward-facing openings, adjusting/modifying the riser height for the stops, adjusting the diameter and/or opening size of the riser, and so forth, to adjust the flame-stopping performance. As used herein, the wick is “substantially” aligned in a straight line when at least the portion of the wick between the base member and the top end of the wick is aligned in the straight line. It is also pointed out that, in some implementations the removable stop may have multiple bases. For example, FIGS. 4-6 show each removable stop having a single base 122, but in some cases each removable stop could have two or three or more bases (such as to provide more pull tabs for removing the stop from the wick). In some cases each removable stop could have two bases opposite one another (e.g., on opposite sides of the same opening at an end of the riser) so that they both extend outward from the riser to create a wing-like configuration/appearance.

FIG. 4 shows that the stops may be positioned at equal or substantially equal intervals along the wick (in other words, with equal spacing between each neighboring pair of stops). Substantially equal intervals, as used herein, refer to each interval being at least eighty percent of the length of each other interval. This may be useful in that, then, the amount of burning time between each stop could be equal or substantially equal, and may allow the burning of the candle to be predictable (or somewhat predictable). Such time increments may be detailed to the user, and could even be used for time tracking. For example a user could light a candle, with known twenty-minute increments between stops, as a visual reminder to keep the user on track with a task for twenty-minutes. This may also be useful in a daily routine, for example the user lighting a candle daily while bathing or reading the news or the like and the flame extinguishment being a reminder to leave for work. In implementations, however, the stops may not be positioned at equal intervals, but may be positioned at non-equal intervals for various purposes (such as to provide varying burn times) and/or as desired by the user.

The various devices and/or assemblies disclosed herein and their elements, sub-elements, sub-assemblies, and so forth may be formed from any materials that will feasibly allow, facilitate, and/or otherwise not hinder their respective functions as described herein. For example, any of the devices, elements, or sub-elements may, wherever possible, be formed of metals, polymers, composites, ceramic materials, fabrics, and so forth. Nevertheless, in implementations one or more elements may be formed of specific elements disclosed herein and may thereby have advantages/benefits as are set forth herein or as will be understood by the practitioner of ordinary skill in the art.

Furthermore, there are a variety of ways in which the various elements may be directly or indirectly coupled together. Notwithstanding the specific ways in which elements are depicted as being coupled together herein, these same elements could, wherever feasible, be joined together in any of the following ways: manually removably coupled together such as using a friction fit, a removable/reusable adhesive, and any other type of manually removable coupling mechanism; or fixedly/permanently coupled together such as using a permanent adhesive, soldering, melt joining or heat bonding, sewn elements, stitching, and any other type of permanent coupling mechanism that is not manually removable. Manually removable, as defined herein, refers to the ability to remove a coupling using manual force either using hands alone or using non-powered hand tools.

The above-described elements may in implementations be configured or arranged in a variety of arrangements, each arrangement with its own advantages as will be understood by the practitioner of ordinary skill in the art, notwithstanding the specific example arrangements which are discussed above and representatively illustrated in the drawings.

As used herein, the term “metallic” refers to any metal or metal alloy.

In implementations any completed/formed candles including the wick assembly could be provided to users. Alternatively or additionally, an assembled wick assembly could be provided for users to combine with a flammable medium to form a candle. Alternatively or additionally, a wick apparatus (comprising multiple elements of a wick assembly, at least some of which are unassembled, such as a wick and separate removable stops which are not yet secured to the wick) could be provided for users to form their own wick assemblies (such as by coupling one or more removable stops and/or base members to each wick at desired locations) and then to form candles by integrating each assembled wick assembly within a flammable medium. Alternatively or additionally, a candle apparatus (comprising multiple elements of a candle, at least some of which are unassembled) could be provided for a user to form a candle, the candle apparatus including one or more flammable mediums, one or more wicks, one or more removable stops either already coupled with the wick or separate from the wick for the user to couple with the wick at one or more desired locations to form a wick assembly, optionally one or more base members either already coupled with the wick or separate from the wick for the user to couple with the wick at one or more desired locations to further form the wick assembly, optionally an adhesive to secure the one or more base members to the wick to further form the wick assembly, and optionally a container for containing the flammable medium and the formed wick assembly. Such candle apparatuses may be candle-making kits and could include one or more flammable mediums of different colors and scents (for example a kit with multiple scented waxes of different colors for the user to stack/mix the wax elements as desired in the finished candle) and/or other elements to combine with the flammable medium such as flower petals or other plant components, scented elements, visual elements (such as glitter or other elements to be added to the flammable medium for aesthetic appeal), and so forth.

As used herein, the term “apparatus” means a group of elements designed for a particular use and either already coupled together, or configured to be coupled together, for the particular use.

For convenience, a list of elements depicted in the drawings (along with their corresponding element numbers) is provided below:

candle 100
container 102
flammable medium 104
molten portion 104B
wick assembly 105
wick 106
top end 108A
burned portion 108C
remainder 108D
top portion 108E
base member 110
base 112
riser 114
curved surface 116
opening 118
adhesive 120
removable stop 122
base 124
riser 126
curved surface 128
opening 130
flame 109

While each individual above-described element may be configured as shown in the drawings and/or as discussed above, these are only representative examples and other configurations are possible for any individual element, with various advantages and tradeoffs as will be understood by the practitioner of ordinary skill in the art.

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of candles and related components and methods, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Additionally, in places where a claim uses the term “first” as applied to an element, this does not imply that the claim requires a second (or more) of that element-if the claim does not explicitly recite a “second” of that element, the claim does not require a “second” of that element. Furthermore, in some cases a claim may recite a “second” or “third” or “fourth” (or so on) of an element, and this does not necessarily imply that the claim requires a first (or so on) of that element-if the claim does not explicitly recite a “first” (or so on) of that element (or an element with the same name, such as “a widget” and “a second widget”), then the claim does not require a “first” (or so on) of that element.

Method steps disclosed anywhere herein, including in the claims, may be performed in any feasible/possible order. Recitation of method steps in any given order in the claims or elsewhere does not imply that the steps must be performed in that order-such claims and descriptions are intended to cover the steps performed in any order except any orders which are technically impossible or not feasible. However, in some implementations method steps may be performed in the order(s) in which the steps are presented herein, including any order(s) presented in the claims.

What is claimed is:

1. A candle, comprising:
a flammable medium that is at least semi-solid; and
a wick assembly at least partially integrated within the flammable medium, the wick assembly comprising:
a wick comprising a top end and a bottom end; and
a stop coupled with the wick between the top end and the bottom end;
wherein the stop substantially prevents the candle from burning beyond the stop until the stop is removed; and
wherein the stop is configured to be manually removed, after the wick has burned from the top end to the stop, to substantially separate a burned portion of the wick from a substantially non-burned top portion of a remainder of the wick, the substantially non-burned top portion capable of being ignited to re-light the candle.

2. The candle of claim 1, wherein the stop comprises a base, a hollow riser coupled with the base, and an opening at an end of the hollow riser, and wherein the wick passes through the opening and through the hollow riser.

3. The candle of claim 2, wherein the stop is positioned so that the hollow riser extends away from the base and toward the top end of the wick.

4. The candle of claim 2, wherein the stop is positioned so that the hollow riser extends away from the base and toward the bottom end of the wick.

5. The candle of claim 2, wherein the hollow riser is crimped to secure the stop to the wick.

6. The candle of claim 1, wherein the stop is formed of a metal or a metal alloy.

7. The candle of claim 1, further comprising one or more additional stops coupled with the wick between the top end and the bottom end.

8. The candle of claim 7, wherein the stop and the one or more additional stops are positioned at substantially equal intervals along the wick.

9. The candle of claim 1, further comprising a base member proximate or at a bottom of the candle and proximate or at the bottom end of the wick, the base member comprising:
a base;
a hollow riser coupled with the base; and
an opening at an end of the hollow riser;
wherein the wick passes through the opening and through the hollow riser.

10. The candle of claim 9, wherein the base member is positioned so that the hollow riser extends away from the base and toward the top end of the wick.

11. A candle apparatus, comprising:
a wick comprising a top end and a bottom end; and
a stop comprising a metallic hollow riser having an opening, wherein the stop is configured to secure to the wick between the top end and the bottom end, by passing the wick through the opening and through the metallic hollow riser, to form a wick assembly;
wherein the wick assembly is configured to be at least partially integrated within a flammable medium to form a candle;
wherein the stop, when secured to the wick, is configured to extinguish a flame consuming the wick as the flame approaches the stop; and
wherein the stop is configured to be manually removable, after the wick has burned from the top end to the stop, to substantially separate a burned portion of the wick from a substantially non-burned top portion of a remainder of the wick, the substantially non-burned top portion capable of being ignited to re-light the wick.

12. The candle apparatus of claim 11, wherein the stop is secured to the wick.

13. The candle apparatus of claim 12, wherein the stop is secured to the wick by the wick being situated at least partially within the metallic hollow riser and the metallic hollow riser being crimped.

14. The candle apparatus of claim 11, further comprising the flammable medium.

15. The candle apparatus of claim 11, wherein the stop further comprises a base coupled with the metallic hollow riser, the base forming a pull tab.

16. The candle apparatus of claim 15, wherein the stop is secured to the wick and is positioned so that, when the wick is substantially aligned in a straight line, the metallic hollow riser extends away from the base and toward the top end of the wick.

17. The candle apparatus of claim 15, wherein the stop is secured to the wick and is positioned so that, when the wick is substantially aligned in a straight line, the metallic hollow riser extends away from the base and toward the bottom end of the wick.

18. The candle apparatus of claim 11, further comprising a base member configured to secure to the bottom end of the wick, the base member comprising:
a base;
a hollow riser coupled with the base of the base member; and
an opening at an end of the hollow riser of the base member;
wherein the wick is configured to secure to the base member at least in part by the wick passing through the opening of the base member and through the hollow riser of the base member.

19. A method of forming a candle, comprising:
providing a wick having a top end and a bottom end;
providing a stop comprising:
a base; and
a hollow riser having an opening;
passing the wick through the hollow riser and through the opening so that the stop is positioned between the top end and the bottom end;
securing the stop to the wick to form a wick assembly;
situating the wick assembly at least partially within a flammable medium while the flammable medium is in an at least semi-liquid state; and
solidifying the flammable medium to an at least semi-solid state with a first portion of the wick assembly within the flammable medium and a second portion of the wick assembly outside the flammable medium, to form a candle;
wherein the stop is configured to extinguish a flame consuming the candle as the flame approaches the stop; and
wherein the stop is configured to be manually removable, after the wick has burned from the top end to the stop, to substantially separate a burned portion of the wick from a substantially non-burned top portion of a remainder of the wick, the substantially non-burned top portion capable of being ignited to re-light the candle.

20. The method of claim 19, wherein forming the wick assembly further comprises:
providing a base member comprising:
a base;
a hollow riser coupled with the base of the base member; and
an opening at an end of the hollow riser of the base member;
passing the bottom end of the wick through the opening of the base member and through the hollow riser of the base member; and
securing the bottom end of the wick to the base member;
wherein positioning the wick assembly at least partially within the flammable medium comprises positioning the base member at least partially within the flammable medium.
